(19) United States
(12) Patent Application Publication
(10) Pub. No.: US 2026/0351910 A1
(43) Pub. Date: Nov. 5, 2026

(54) BENDABLE AND POSITIONABLE SIGNAL CONNECTION HEAD

(71) Applicant: NIEN-YI INDUSTRIAL CORPORATION, Taipei City (TW)

(72) Inventor: Kuei-Hsin HUANG, Taipei City (TW)

(21) Appl. No.: 19/198,169

(22) Filed: May 5, 2025

(51) Int. Cl. H01R 24/64; H01R 13/58; H01R 107/00

(52) U.S. Cl. CPC H01R 24/64; H01R 13/5841; H01R 2107/00; H01R 2201/04

(57) ABSTRACT

A bendable and positionable signal connection head includes a signal connector, a signal line fixing member, and a metal strip. The signal connector includes a first signal connection part electrically connected to a second signal connection part of the signal line fixing member. An opposite end of the signal line fixing member is provided with an insulation sleeve connected with a signal line. The signal line is electrically connected to the second signal connection part. At least one metal strip that is flexible is arranged in the insulation sleeve. As such, by means of the flexibility, and thus bendability, of the metal strip, the insulation sleeve of the signal line fixing member correspondingly exhibits flexibility for bending and positioning so as to provide a user with an arrangement for various angles of bending and positioning on the signal line to which the signal connector is connected according to installation requirements.

### BACKGROUND OF THE INVENTION

### (a) Technical Field of the Invention

The present invention relates to a bendable and positionable signal connection head, and more particularly to a signal connection head that enables bending and positioning of a signal line connected thereto at various angles.

### (b) Description of the Prior Art

Nowadays, computer technology is developing rapidly. Desktop computers or notebook computers are widely used in every corner of society. With the rise and popularization of network technology, various computer hosts, network switches, or terminal servers are equipped with network connectors for connection with network plugs. Most of these network connectors are registered jack (RJ) type, which allows computer hosts and other electronic devices to be connected to the Internet through RJ network connectors to form a communication bridge for data transmission between the computer hosts and external networks.

As for an RJ45 plug connector, the local area network (LAN) cable connected therewith is gradually being widely used for signal transmission and reception between communication devices. The RJ45 plug connector and socket use specifications that are universal worldwide, and they can be easily obtained anywhere in the world. An LAN cable includes 8-pole 8-core signal wires, and thus, the RJ45 plug connector and the LAN cable thereof are most suitable for use as communication cables.

However, the protective cover structure provided at the connection between a conventional RJ45 plug and a LAN cable cannot be effectively bent and positioned at various angles, resulting in the LAN cable at the end of the RJ45 plug being in a naturally hanging form for use. If there are multiple RJ45 plugs and LAN cables used at the same time, the LAN cables will appear quite messy. In addition, the LAN cable of the conventional RJ45 plug cannot provide users with the ability to arbitrarily bend for line arrangement, configure and position the LAN cable of the RJ45 plug according to installation requirements.

Thus, the primary issue that the present invention aims to solve is to provide a signal line connected to a signal connector with bendability and positionability for various angles.

### SUMMARY OF THE INVENTION

The primary objective of the present invention is to provide a bendable and positionable signal connection head, which comprises a signal connector, a signal line fixing member, and at least one metal strip; the signal connector is a registered jack (RJ) type connector having one end provided with a signal connecting end and an opposite end provided with a first signal connection part, the signal connecting end being insertable into and connectable with a preset external signal socket (such as an RJ connector); the signal line fixing member is connected to the signal connector and is connected to a preset signal line, the signal line fixing member having one end provided with a second signal connection part and an opposite end provided with an insulation sleeve, the second signal connection part being electrically connected to the first signal connection part of the signal connector, the insulation sleeve being sleeved over and connected to one end of the preset signal line to have the one end of the signal line fixed in the interior of the insulation sleeve, the signal line being electrically connected to the second signal connection part; the metal strip is disposed in the interior of the insulation sleeve of the signal line fixing member, the metal strip being of a property of flexibility for bending and positioning, so as to make the insulation sleeve of the signal line fixing member correspondingly exhibit flexibility for bending and positioning.

The main technical feature of the present invention is that the insulation sleeve of the signal line fixing member is sleeved over and connected with one end of a preset signal line, and at least one or more than one metal strip that is of flexibility is disposed in the interior of the insulation sleeve, wherein by means of the metal strip being arbitrarily bendable and deformable in various ways, the insulation sleeve of the signal line fixing member correspondingly exhibits flexibility for bending and positioning in various ways, and as such, implementation of bending for line arrangement and configuration in various ways on the signal line of the signal connector can be performed by the user according to the installation requirements. For example, the signal line at the tail end of the signal connector can be bent down in the vertical direction to avoid an obstacle or to be used in a gap, so as to make full use of the limited space and avoid the signal line being in a naturally hanging form, which causes the signal line to be quite messy.

### BRIEF DESCRIPTION OF THE DRAWINGS

FIG. 1 is a perspective view showing a bendable and positionable signal connection head according to the present invention.

FIG. 2 is an exploded view showing the bendable and positionable signal connection head according to the present invention.

FIG. 3 is a cross-sectional view showing a first illustrative example of the bendable and positionable signal connection head according to the present invention.

FIG. 4 is a cross-sectional view showing a second illustrative example of the bendable and positionable signal connection head according to the present invention.

FIG. 5 is a schematic view showing an example of implementation of bending of the bendable and positionable signal connection head according to the present invention.

### DETAILED DESCRIPTION OF THE PREFERRED EMBODIMENTS

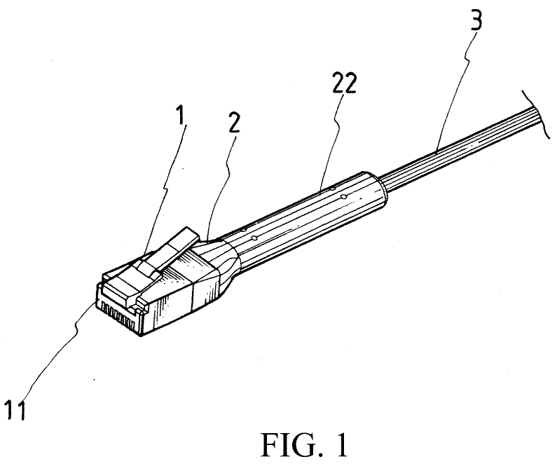

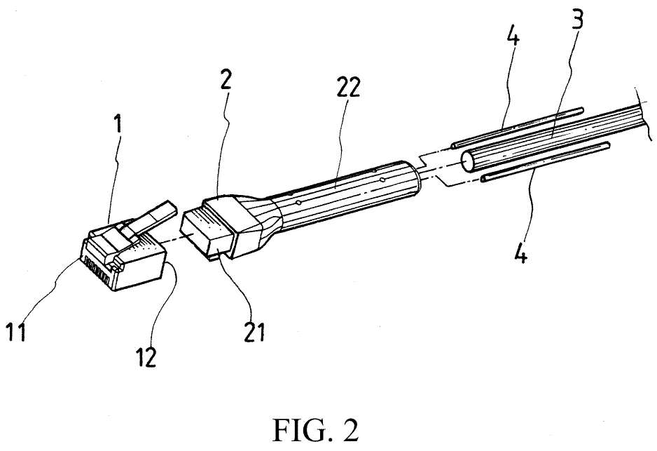

Referring to FIGS. 1-5, the present invention discloses a bendable and positionable signal connection head, which comprises a signal connector 1, a signal line fixing member 2, and at least one or more than one metal strip 4.

The signal connector 1 is provided, at one end thereof, with a signal connecting end 11 and is also provided, at an opposite end thereof, with a first signal connection part 12. The signal connecting end 11 is provided for penetrating into and connecting with a preset external signal socket. For example, the signal connector 1 is a connector of registered jack (RJ) type (such as an RJ45 connector or other connectors of RJ specifications), so that the signal connecting end 11 can penetrate into and connect with a preset external RJ connector.

The signal line fixing member 2 is connected to the signal connector 1 and is connected with a preset signal line 3 (such as a local area network (LAN) cable). The signal line fixing member 2 is provided, at one end thereof, with a second signal connection part 21 and is also provided, at an opposite end, with an insulation sleeve 22. The second signal connection part 21 is in electrical connection with the first signal connection part 12 of the signal connector 1, and the insulation sleeve 22 is sleeved over and coupled with one end of the preset signal line 3, so that the one end of the signal line 3 is enclosed and fixed in the insulation sleeve 22, and the one end of the signal line 3 that is located inside the insulation sleeve 22 is in electrical connection with the second signal connection part 21 to establish electrical connection between the signal connector 1 and the signal line 3.

The at least one or more than one metal strip 4 is disposed in the insulation sleeve 22 of the signal line fixing member 2 and is located on outside of the signal line 3. The metal strip 4 has a property of flexibility, meaning the metal strip 4 is arbitrarily bendable and deformable to fix, so that the insulation sleeve 22 of the signal line fixing member 2 correspondingly exhibits flexibility for bending and positioning in various ways.

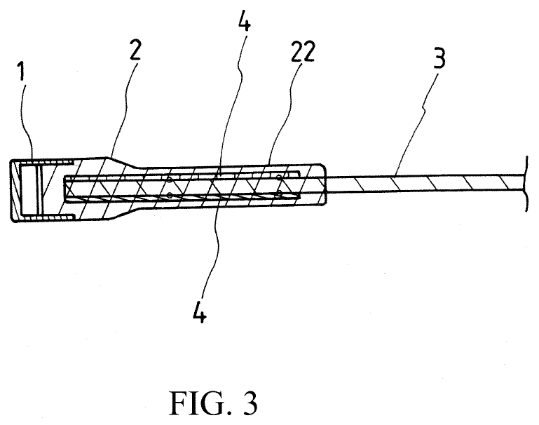

The insulation sleeve 22 of the signal line fixing member 2 encloses the at least one or more than one metal strip 4 therein by means of an integral injection molding process, so that the metal strip 4 is firmly disposed in the interior of the insulation sleeve 22 (as shown in FIG. 3).

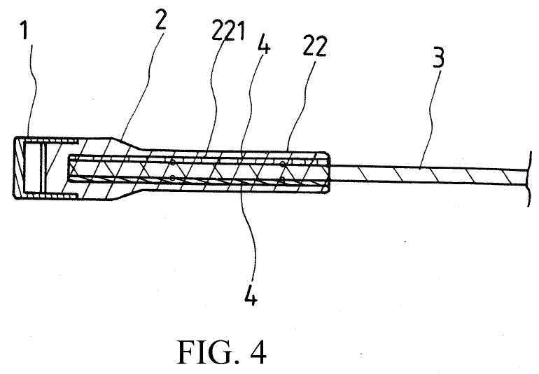

The signal line fixing member 2 may be provided with at least one or more than one fitting groove 221 formed in an inner wall of the insulation sleeve 22. The metal strip 4 is correspondingly inserted, in a tight-fitting manner, into the fitting groove 221 so as to have the metal strip 4 firmly and securely disposed in the interior of the insulation sleeve 22 (as shown in FIG. 4).

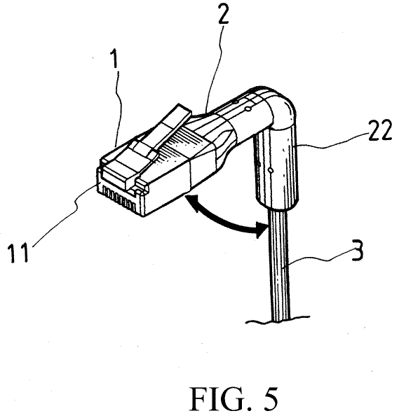

In summary, the main technical feature of the present invention is that the insulation sleeve 22 of the signal line fixing member 2 is sleeved over and connected with one end of a preset signal line 3, and at least one or more than one metal strip 4 that is of flexibility is disposed in the interior of the insulation sleeve 22, wherein by means of the metal strip 4 being arbitrarily bendable and deformable in various ways, the insulation sleeve 22 of the signal line fixing member 2 correspondingly exhibits flexibility for bending and positioning in various ways, and as such, implementation of bending for line arrangement and configuration in various ways on the signal line 3 of the signal connector 1 can be performed by the user according to the installation requirements. For example, the signal line 3 at the tail end of the signal connector 1 can be bent down in the vertical direction (as shown in FIG. 5), or the signal line 3 at the tail end of the signal connector 1 can be bent at any arbitrary angle and direction to avoid or use in a gap, so as to make full use of the limited space and avoid the signal line 3 being in a naturally hanging form, which causes the signal line 3 to be quite messy.

I claim:

1. A bendable and positionable signal connection head, comprising:
a signal connector, which has one end provided with a signal connecting end and an opposite end provided with a first signal connection part, the signal connecting end being adapted to penetrate into and connect with a preset external signal socket;
a signal line fixing member, which is connected to the signal connector and is connected to a preset signal line, wherein the signal line fixing member has one end provided with a second signal connection part and an opposite end provided with an insulation sleeve, the second signal connection part being in electrical connection with the first signal connection part of the signal connector, the insulation sleeve being sleeved over and connected to one end of the signal line, the signal line being in electrical connection with the second signal connection part; and
at least one metal strip, which is disposed in an interior of the insulation sleeve of the signal line fixing member, wherein the metal strip is of flexibility, so as to make the insulation sleeve of the signal line fixing member exhibit flexibility for bending and positioning.

2. The bendable and positionable signal connection head according to claim 1, wherein the insulation sleeve encloses the metal strip through integral injection molding.

3. The bendable and positionable signal connection head according to claim 1, wherein an inner wall of the insulation sleeve is formed with at least one fitting groove, and the metal strip is correspondingly inserted, in a tight-fitting manner, into the fitting groove.

4. The bendable and positionable signal connection head according to claim 1, wherein the signal connector comprises a registered jack (RJ) connector.
